(19) United States
(12) Patent Application Publication
(10) Pub. No.: US 2019/0335690 A1
(43) Pub. Date: Nov. 7, 2019

(54) SOILLESS CULTURE FACILITY

(71) Applicant: COMBAGROUP, Molondin (CH)

(72) Inventor: Benoit de Combaud, Saint Cierges (CH)

(21) Appl. No.: 16/310,299

(22) PCT Filed: Jun. 14, 2017
(86) PCT No.: PCT/EP2017/064631

§ 371 Date: Dec. 14, 2018

(30) Foreign Application Priority Data
Jun. 14, 2016 (FR) 1655496

(51) Int. Cl. A01G 31/04; B65G 35/04

(52) U.S. Cl. CPC A01G 31/045; B65G 35/04

(57) ABSTRACT

A soilless culture facility includes a frame supporting a plurality of profile sections extending parallel to each other in a horizontal plane, from a transverse loading area to a transverse harvesting area, and a plurality of supports, each suitable for receiving a culture substrate. The plurality of supports are longitudinally movable in the longitudinal gap defined by two adjacent profile sections. The movable supports are moved by a motor means suitable for modifying the distance between two consecutive supports during travel in the gap. The plurality of profile sections have opaque and flexible longitudinal joining side band strips, the joining side band strips of two adjacent profile sections joining to close the gap defined by the adjacent profile sections. The movable supports have arcuate slots in the front and rear cross-sections of same, to either side of a longitudinal vertical plane, the two band strips joining at the lower edge.

### CROSS-REFERENCE TO RELATED APPLICATIONS

This application is a national phase entry under 35 U.S.C. § 371 of International Patent Application PCT/EP2017/064631, filed Jun. 14, 2017, designating the United States of America and published as International Patent Publication WO 2017/216267 A1 on Dec. 21, 2017, which claims the benefit under Article 8 of the Patent Cooperation Treaty to French Patent Application Serial No. 1655496, filed Jun. 14, 2016.

### TECHNICAL FIELD

The present disclosure concerns the field of soil-less cultivation, notably hydroponics and a particular version of aeroponics.

### BACKGROUND

For this type of cultivation, the plants are grown on a neutral and inert substrate (such as sand, pozzolana, clay balls, rock wool, etc.). This substrate and the plant's root system are regularly irrigated with a stream of solution that provides mineral salts and essential nutrients to the plant, which is provided by soaking for hydroponic cultivation and by misting on the roots for aeroponic cultivation.

Aeroponics cultivation is more complex to implement, but allows a better oxygen supply to the roots and naturally prevents the risk of cross-contamination by root contact.

Many crop installation configurations have been proposed. The present disclosure relates more particularly to installations with a flat area of cultivation, allowing natural sunlight to be provided, unlike three-dimensional or multi-story solutions.

The French patent application FR/3024816 by the applicant is known in the prior art. This patent describes an installation for soil-less cultivation comprising a plurality of juxtaposed systems, each of which moves plants along a production line. The plant displacement systems are configured to move a plant between a feeding end of the production line and a picking end of the production line for a time corresponding to the maturation period of the plant, and to modify the distance between two consecutive plants along at least one of the longitudinal or transverse axes over at least a part of the production line.

U.S. Pat. No. 5,323,567 concerns a plant cultivation facility using an artificial light source. Partitions with high light reflectance are placed in a growing area to divide the same into small spaces. In each small space, a plate reflects the light.

Pallet sets carrying plants are arranged in rows in a growth chamber and are moved in a radial direction according to the growth of the plants. The peripheral surface of the growth chamber is covered with a reflective plate with high light reflectance.

Dutch patent application NL8401638 describes a plastic gutter closed at its front and rear ends for growing plants on an aqueous culture medium. The plants are inserted into a moss block that is engaged in a groove in which they are held, in the variant illustrated in FIG. 5 therein, by elastic locking tabs 21.

Also known is the patent application US2013/014435 describing a system for growing off-ground plants using removable V-shaped baskets to support the plants in an autonomous tiered unit. The nutrient-enriched water is sprayed on the roots of the plant. The roots are held by perforations in the elongated V-shaped basket and a plant cover.

Baskets can be made up of a pair of identical halves that can be mutually coupled. Coupling mechanisms may include those that combine and those that provide for pivoting coupling.

Prior art solutions are generally satisfactory. However, in real industrial use, they may lack strength and reliability.

Indeed, these are installations intended to operate 24 hours a day, 7 days a week, and all year round, under harsh conditions for the mechanisms: humidity, temperature, UV, plant cycles, etc.

The general architecture of the installation, the design of components and mechanisms must, therefore, withstand these operating conditions with a minimum failure rate and need for maintenance and supervision.

In addition, it is important to separate as best as possible the upper space where the aerial part of the plant develops from the lower part, where the root system and irrigation or misting equipment are located. This separation must be both physical, by providing a barrier, not perfectly waterproof but limiting exchanges between the two spaces, and optical, to limit the lighting of the lower part. Indeed, the supply of light in the lower part promotes the development of micro algae and pathogens.

The prior art documents do not provide any solution to the problem of the sealing between the upper and lower parts. On the contrary, in U.S. Pat. No. 5,323,567, even in the design proposed in reference to FIG. 20 and following, the slot allowing the passage of pallets receiving the plants constitutes a passage for light and material elements.

The solution described in patent NL8401638 does not provide for the movement of plane supports along the entire length of the profile but, on the contrary, provides for the locking of the support in a fixed position. The referred lifts (21) do not have a sealing function but a locking function for the blocks in which the plants are inserted. Moreover, the shape of the blocks would in no way ensure water tightness since the areas in front and behind the block are necessarily open.

### BRIEF SUMMARY

The present disclosure aims to solve these technical problems by proposing, in its most general sense, an installation for off-ground cultivation comprising a frame supporting a plurality of profiles extending parallel in a horizontal plane, from a transverse loading area to a transverse harvesting area, and a plurality of supports, each suitable for receiving a cultivation substrate. The plurality of supports are longitudinally movable in the longitudinal gap defined by two adjacent profiles. The movable supports are driven by motorized means capable of changing the distance between two consecutive movable supports during the stroke in the gap. The plurality of profiles have opaque flexible longitudinal joint side strips, the joint side strips of two adjacent profiles meeting to ensure a closure of the gap defined by the two adjacent profiles. The movable supports have in their front and rear cross-sections arched slots on either side of a longitudinal vertical plane, the arched slots joining at the lower edge.

The disclosure also concerns the supports for such installations.

### BRIEF DESCRIPTION OF THE DRAWINGS

This disclosure will be better understood upon reading the following detailed description of a non-restrictive exemplary embodiment, while referring to the accompanying drawings, wherein:

FIG. 1 shows a perspective view of an installation according to one embodiment of the disclosure;

FIG. 2 shows a cross-sectional view of a profile embodying the disclosure;

FIG. 3 shows a cross-sectional view of a support and a driving housing;

FIG. 4 shows an above to rear perspective view of the support;

FIG. 5 shows a bottom view of the lower shell of the support;

FIGS. 6 and 7 show, respectively, bottom and top views of the upper shell of the support;

FIGS. 8 and 9 represent views of the driving housing, respectively, in active and in inhibited positions; and

FIG. 10 is a perspective view of the driving means of the supports.

### DETAILED DESCRIPTION

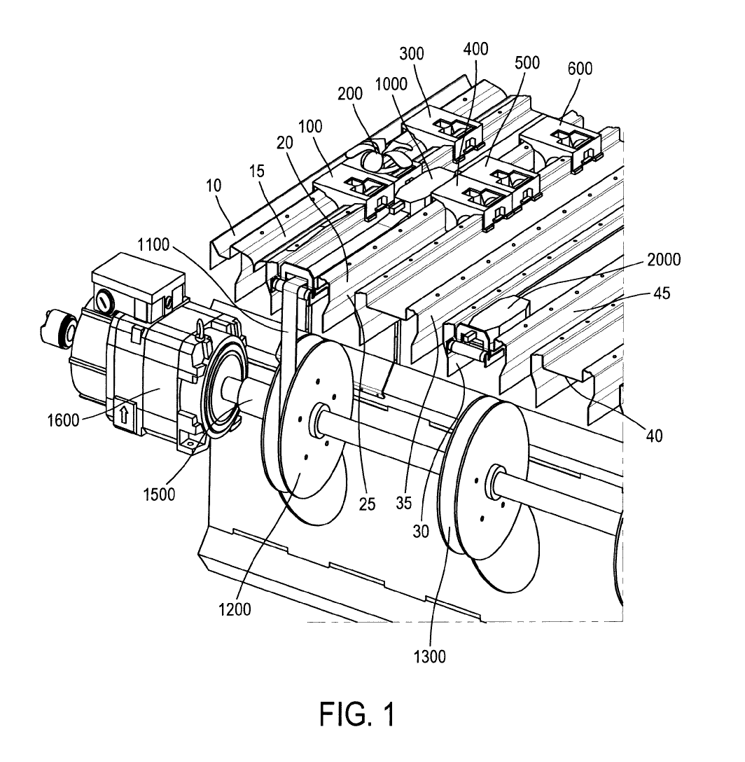

FIG. 1 is a partial schematic view of an example of an installation according to the disclosure.

The installation comprises a bundle of parallel profiles 10, 20, 30, 40 extending in a horizontal plane between a transverse loading area and a transverse harvesting area. These profiles define a plane separating the upper space, illuminated by natural or artificial light, in which the aerial part of the grown plants develops, and the lower space, equipped with irrigation means in the case of hydroponic cultivation or misting means in the case of aeroponic cultivation, this lower space being in darkness to limit the proliferation of micro-organisms, particularly micro-algae.

The profiles are spaced two by two to define a gap 15, 25, 35, 45 for moving supports 100, 200, 300, 400, 500, 600. Driving housings 1000, 2000 driven by belts 1100 slide on the surface of the profile to drive the supports 100, 200, 300, 400, 500, 600 from the loading area to the harvesting area during a cycle corresponding to the plant's maturation period. The purpose of this movement is not only to bring the supports from the loading area to the harvesting area during a cycle corresponding to the growth period, but also to increase the spacing between two consecutive supports on the same line, as the volume of the aerial part of the plant increases. For salad-type plants, the space occupied by the leaves increases from zero, when the support contains a seed, to a volume of foliage occupying a space of several tens of centimeters in diameter at the time of harvest.

Typically, the length of the profiles is between 60 meters and 120 meters, and is generally 90 meters, to allow the loading of about ten simultaneous supports, with progressive maturation stages.

The installation includes on the loading side and on the harvest side, a transverse motorized shaft 1500 driven by a motor 1600. This motorized shaft 1500 is equipped with drums 1200, 1300 driving the belts 1100. If necessary, each drum 1200, 1300 includes a clutch means allowing coupling or disconnection with the motorized shaft 1500, and thus to individually move each of the driving housings 1000, 2000.

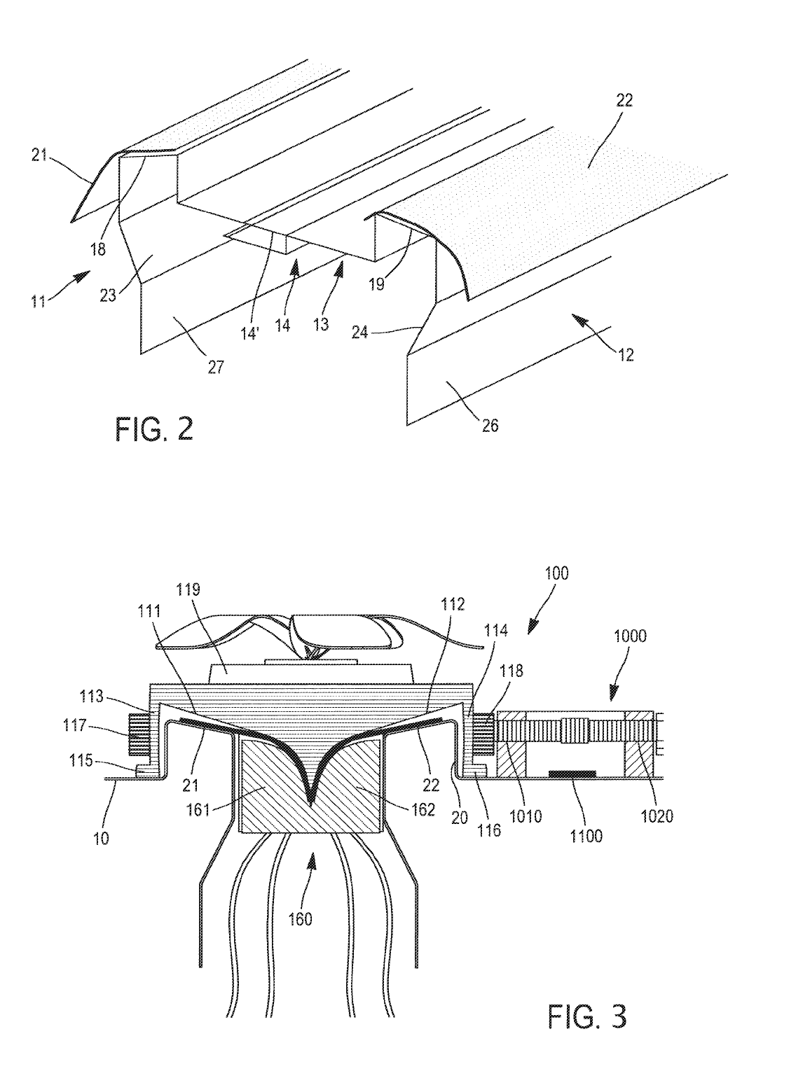

FIG. 2 shows a cross-sectional view of a profile according to one embodiment of the disclosure.

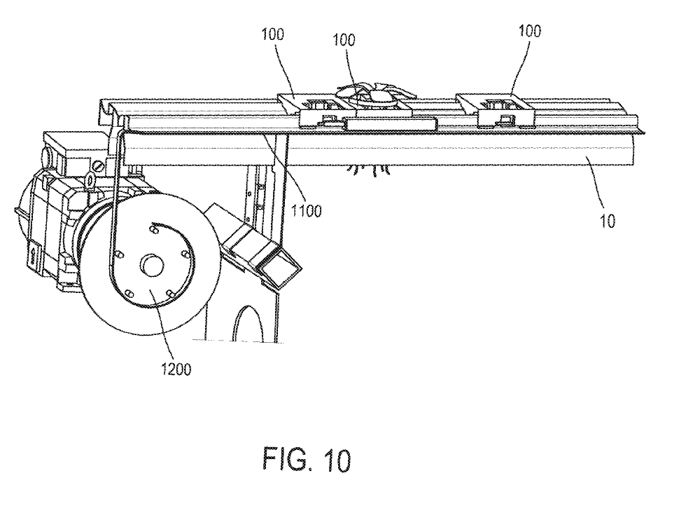

FIG. 10 is a perspective view of the driving means of the supports.

The profile is preferably made of galvanized steel covered with a double or triple plastic coating and formed in situ.

The profile 10 has two lateral flanks 11, 12 on either side of a transverse upper face 13.

The upper side has a groove 14 in which the driving housing 1000 moves. Optionally, the bottom of this groove 14 has a second groove 14′ of trapezoidal cross-section for longitudinal and vertical guidance of the driving housing 1000, which then has an additional section shoe that engages in this second groove 14′.

On either side of the guide area of the driving device, the groove 14 has a sliding area for skids provided on lateral extensions of the supports 100.

On either side of the central groove 14 the profile has a surface 18, 19 inclined by about 10° with respect to the horizontal plane to which band strips 21, 22 are respectively fixed.

These band strips consist of opaque silicone strips with a thickness of approximately 2 mm to 5 mm, fixed on the inclined surface 18, 19 by rivets or anchoring systems, with an extension of 4% to 10% of the nominal length. These band strips 21, 22 have elastic flexibility and fall back at rest to form an angle of about ten degrees with the vertical plane.

When two profiles are in place, they define a gap in which the respective band strips 21, 22 meet at their lower edges to have a “V” cross-section at rest. The slope of the lower part of the band strips 21, 22 is determined so that their lower edges meet when the profiles are spaced at an interval corresponding to the nominal width of the gaps.

By elastic deformation, it is possible to locally push the seal of band strips 21, 22 back into position so that it approaches the corresponding flank 11, 12, respectively, for example, when a support 100 is present, and returns to position due to its elasticity.

These band strips 21, 22 ensure the closure of the gaps formed between two consecutive profiles over the entire length that is not occupied by a movable support.

The lateral flanks 11, 12 have a part 23, 24 inclined toward the inside of the profile, to free space for the deployment of the roots of the plants moved in the supports. This inclined part 23, 24 is extended in the example described by a vertical part 26, 27, which rests at regular intervals on jib cranes (not shown) fixed to the ground.

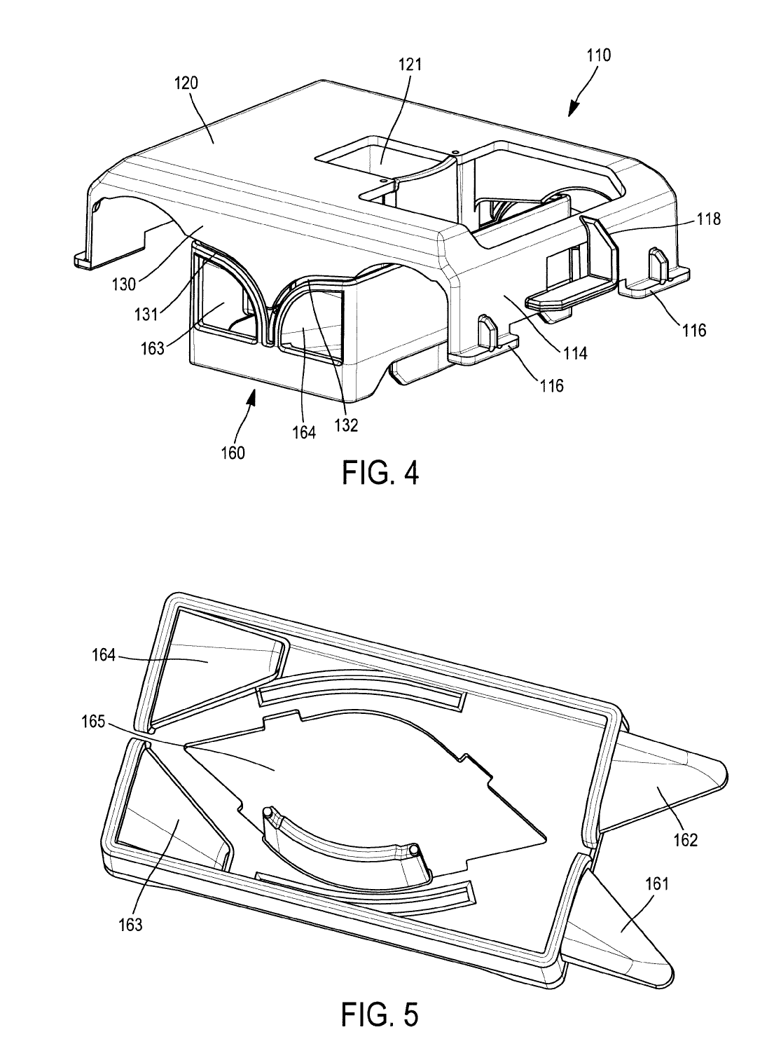

FIG. 3 shows a cross-sectional view of a support 100 and a driving housing 1000, at a moment when both are coupled to each other. FIGS. 4 to 7 show the details of the construction of the support 100.

The support 100 consists of the assembly of an upper shell 110 and a lower shell 160. These shells 110, 160 are made of molded plastic and clipped together.

The lower shell 160 has two front extensions 161, 162 in the shape of a quarter ogive.

The upper shell 110 has on its front face a cut-out 111, 112 in a shape complementary to the transverse surface of the extensions 161, 162 to define a slot for the passage of the band strips 21, 22.

The semi-ogival shape of the front extensions 161, 162 forces the deformation of the band strips 21, 22 between a configuration where the two contacting band strips 21, 22 have a “V” configuration, in front of the support toward a shape where they move away from one another to allow the passage of the plant housing and the root part, before returning to the “V” configuration.

The upper shell 110 has lateral extensions 113, 114 delimiting a channel of complementary cross-section to the lateral edge of the profile. These lateral extensions 113, 114 have at their lower end a pad 115, 116 designed to slide on the upper surface of the profile 10, 20.

These lateral extensions 113, 114 are provided with a shoulder 117, 118 designed to cooperate with the finger 1010, 1020 of the driving housing 1000. This driving housing 1000 is driven by the belt (1100.

The upper shell 110 has a slot to receive a bucket 119 containing the growth substrate.

FIG. 4 shows a top-rear view of the support. It has a slot 121 on its upper side 120 to receive the culture substrate.

The lower shell has two longitudinal slots of semi-ogival inner shape 163, 164 complementary to the outer shape of the front extensions 161, 162. This allows these areas to be interlocked and two consecutive lower shells to be stacked in the loading area where it is not yet necessary to space the supports.

The upper shell 110 has a rear face 130 which, like the front face, has curved lower edges 131, 132 to form a passage slit with the lower shell 160 through which the band strips 21, 22 may pass.

The arched slit defined by the adjacent edges also provides a cleaning function for the band strips 21, 22 by scraping the deposits formed on their surfaces.

The lower shell shown in FIG. 5 has an opening 165 with an upper cross-sectional area to accommodate the substrate, so as to facilitate root passage when the plant has reached its mature size, for example, when separating the lower shell 160 and the upper shell 110 surrounding the plant.

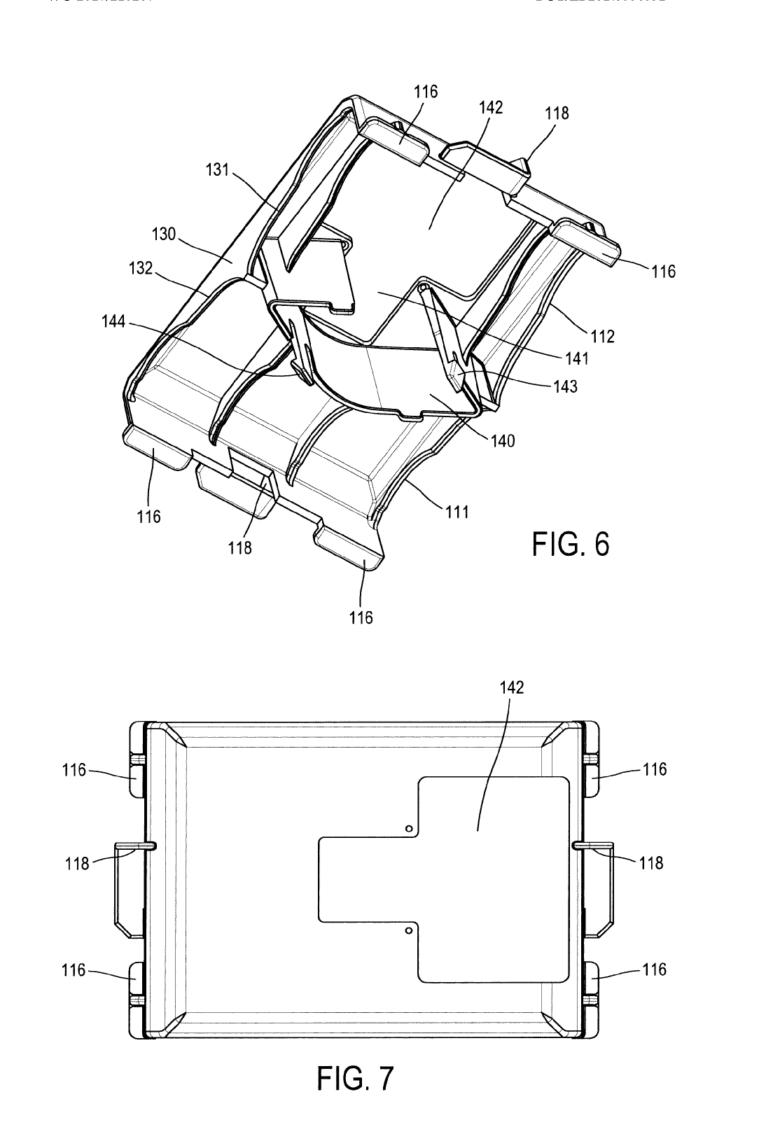

The upper shell 110 shown in FIG. 6 has a semi-cylindrical slot 140 opening through a passage 141 toward a widened opening 142 that opens in the upper face. This slot 140 has hooks 143, 144 on its lower side for clipping into the lower shell 160.

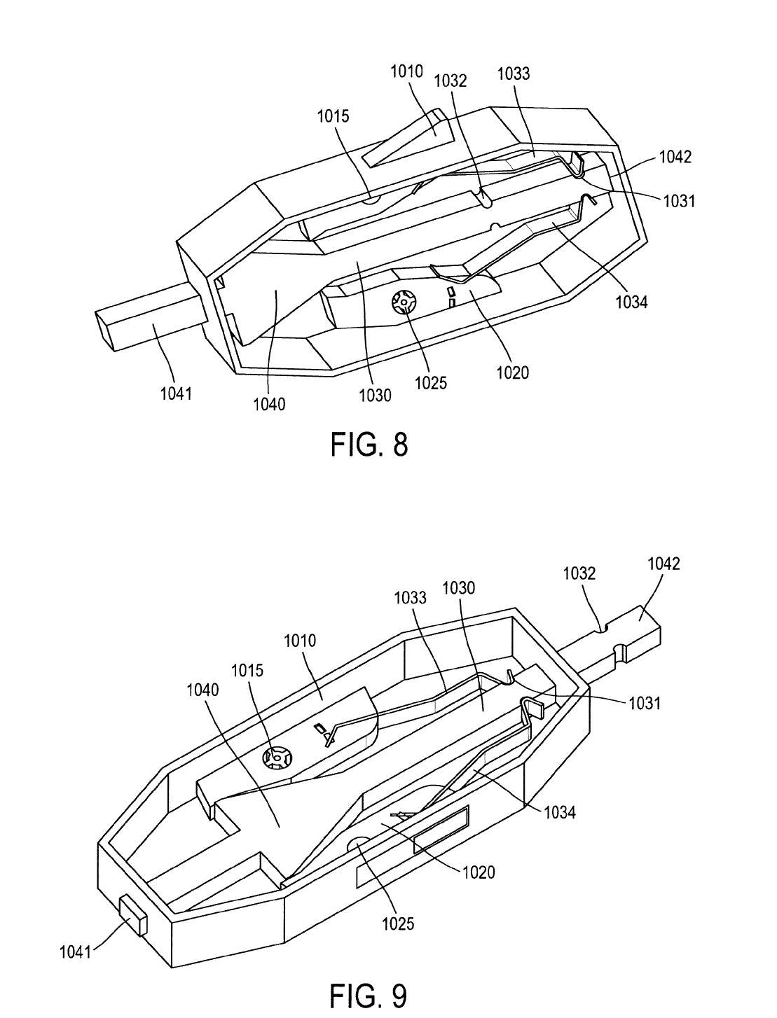

FIGS. 8 and 9 represent views of the driving housing, respectively, in the active and inhibited positions.

The housing includes two fingers 1010, 1020 articulated by pivots 1015, 1025. The housing has a longitudinal rod 1030 extending beyond both the front and rear front walls of the housing. This longitudinal rod 1030 has a triangular area 1040 that causes the fingers 1010, 1020 to retract into one position, and frees the movement of the fingers 1010, 1020 in the other position.

The longitudinal rod 1030 has two peripheral grooves 1031, 1032 in which the end of springs 1033, 1034 engage.

When the end 1041, which is on the widest side of the triangular area 1040 and on the front side, considering the direction of movement of the supports, comes into contact with a stop provided in the harvesting area, it is moved relative to the housing. The triangular area 1040 then causes the fingers 1010, 1020 to retract. The curved end of the springs 1033, 1034 is accommodated in the groove 1032, and the rod 1030 is held in the inhibition position until the opposite end 1042 contacts an abutment provided in the loading area. The rod 1030 is then pushed back in the opposite direction, and the triangular area 1040 releases the fingers 1010, 1020. The rod is again held in this new position by the curved end of the springs 1033, 1034, which fits into the groove 1031.

This system makes it possible to ensure the driving function of the supports during the cycle of moving the supports from the loading area to the harvesting area, then to reset the movement of the driving means by bringing it back to the side of the harvesting zone without it interacting, during this movement, with the supports it meets.

This equipment operates as follows:

First, a support containing a seed in a substrate is loaded by placing the support in the gap between two profiles. For this purpose, the profiles have an end corresponding to the loading area without joints. The supports can be tightened in this loading area by stacking the ogival areas.

The driving housing moves back and forth to drive the supports of the same line in small jumps. The driving device leaves the harvest area, hooks on to the most advanced support (closest to the loading area), changes direction of travel to drive it a little further forward, then moves back to the loading area to hook on to the next support, then changes direction again to drive this support one jump forward, and so on. When the housing reaches the end of its travel in the loading area, the inhibition mechanism causes the fingers to retract, and the housing can be brought back into the cultivation area to start a new movement cycle.

The housings are driven by belts driven by a driving motorized shaft and a motorized slave shaft at the other end, the latter controlling the tension and movement of the belts.

The support has a marking in the form of a QR code, barcode, color marking or RFID. This marking ensures traceability from the loading of the substrate containing the seed to its installation on the profile. The installation includes readers for code recognition and processing to control the operation of the installation, such as cycle time depending on the seed, or stopping operation in the case of an unrecognized seed or a seed not listed in the seed catalogue.

This disclosure is not limited to the above examples.

In particular,
the belts 1100 can be made of woven strips or of a strip of drilled (flashy) stainless steel,
the drive of the belts 1100 can be carried out either by a main motor and a slave motor, or by a single motor, and a return system to the opposite end, for example, by a drive shaft or a belt.

1.-21. (canceled)

22. An installation for off-ground cultivation, comprising:
a frame;
a plurality of profiles supported by the frame and extending parallel in a horizontal plane from a transverse loading area to a transverse harvesting area; and
a plurality of supports, each support suitable for receiving a cultivation substrate, the plurality of supports being longitudinally movable in a longitudinal gap defined by two adjacent profiles, the supports of the plurality having arched slots on either side of a longitudinal vertical plane in their front and rear cross-sections, the arched slots joining at a lower edge;
a motorized mechanism for driving movement of the plurality of supports, the motorized mechanism being capable of changing a distance between two consecutive movable supports during the stroke in the gap, wherein the plurality of profiles have opaque flexible longitudinal band strips, the band strips of two adjacent profiles meeting to ensure a closure of the gap defined by the two adjacent profiles.

23. The installation of claim 22, wherein the arched slots extend from a lateral edge in a direction forming an angle between 0° and 30° with respect to the horizontal plane to the lower edge in a direction forming an angle between 0° and 30° with a vertical median plane.

24. The installation of claim 22, wherein the lower edge of the band strips has a magnetic device for closing the gap between the lower edge of the band strips.

25. The installation of claim 22, wherein the plurality of profiles have a central longitudinal zone delimited on either side by longitudinal shoulders, the plurality of supports having on either side of the median vertical longitudinal plane extensions defining a longitudinal channel of a cross-section complementary to that of the longitudinal shoulders.

26. The installation of claim 22, wherein each profile of the plurality of profiles guides a driving housing having a coupling feature with adjacent movable supports, each of the driving housings being moved by a belt extending along the corresponding profile.

27. The installation of claim 22, wherein the movable support has lateral skids on either side of the median vertical plane, the lower surface of the skids being intended to slide on the upper surface of the plurality of profiles.

28. The installation of claim 22, wherein each profile has a median longitudinal groove for receiving a strap and the associated driving housing, and wherein the coupling means comprises retractable fingers coming into contact with a shoulder provided on a side wall of the movable supports.

29. The installation of claim 28, wherein the retractable fingers are configured to be pushed back into the removed position when they come into contact with the side wall of a support during a movement toward the loading area of the installation.

30. The installation of claim 28, wherein the driving housings have an inhibition member locking the fingers of the driving housing in the removed position when the inhibition member contacts an abutment located in the loading area, and releasing the retractable fingers when the inhibition member comes into contact with a stop located in the harvesting area.

31. The installation of claim 22, wherein the installation comprises, on the side of the loading area, a first motorized axis driving for each profile a winding drum of a strap whose opposite end is fixed on the driving housing, and on the side of the harvesting area, a second motorized axis driving for each profile a winding drum of a strap whose opposite end is fixed on the driving housing.

32. The installation of claim 31, wherein the installation comprises a computer for controlling the movement of the motorized axes in a sequential manner in order to move, during a cultivation cycle, the driving housings from the transverse harvesting area to the transverse loading area, with alternating short strokes to cause the jumps of the movable supports adjacent to each of the housings.

33. The installation of claim 22, wherein the movable supports have individual markings and wherein the installation has means for reading the markings and controlling operation according to the data acquired during the reading step.

34. A movable support for the installation according to claim 22, wherein the installation for off-ground cultivation comprises a frame supporting a plurality of profiles extending parallel in a horizontal plane, from a transverse loading area to a transverse harvesting area, and a plurality of supports adapted to receive a culture substrate, the plurality of supports being longitudinally movable in the longitudinal gap defined by two adjacent profiles, the movable supports being driven by a motorized means capable of modifying the spacing of consecutive supports during the stroke in the gap, wherein the movable support has, in front and rear vertical transverse planes, arched slits, on either side of the longitudinal vertical plane and extending from the lateral edge in a direction at an angle between 0° and 30° to the horizontal plane to the lower edge in a direction at an angle between 0° and 30° to the vertical median plane, the two arched slits joining at the lower edge.

35. The movable support of claim 34, wherein the movable support has lateral skids on either side of the median vertical plane, the lower surface of the skids being intended to slide on the upper surface of the plurality of profiles.

36. The movable support of claim 34, wherein the movable support has a slot for receiving a culture substrate, the slot opening at the upper and lower surfaces of the movable support.

37. The movable support of claim 36, wherein the slot has means for modifying the interaction with the driving housing according to the presence or absence of the culture substrate.

38. The movable support of claim 36, wherein the slot has support areas against a wall of the culture substrate, and areas defining an air circulation space between the support and the surface of the culture substrate.

39. The movable support of claim 34, wherein the movable support further comprises an individual marking.

40. The movable support of claim 34, wherein the movable support further comprises two complementary shells, the upper shell having a slot for receiving the culture substrate, the lower shell having means for deforming the band strips between, in front and behind the movable support, a position where the lower edges of the band strips meet and, at the movable support, a position where the lower edges of the band strips extend away to free a passage space for the substrate slot and the roots of the plant.

41. The movable support of claim 19, wherein the slot for receiving the substrate opens by a slit to facilitate removal of the plant by a displacement in the longitudinal plane for the exit of the slot, then a vertical displacement to remove it from the upper shell.

42. The movable support of claim 34, wherein the movable support is configured to have a stable base suitable for transporting a salad after leaving the line on a conveyor belt and to a centralized harvesting station.
